(19) United States
(12) Patent Application Publication
(10) Pub. No.: US 2010/0221562 A1
(43) Pub. Date: Sep. 2, 2010

(54) MULTI-LAYERED FOOD WRAPPING MATERIAL

(76) Inventor: Veronica Hawkins-Garcia, Jamaica, NY (US)

Correspondence Address: Thomas M. Galgano, 20 W. Park Avenue, Suite 204, Long Beach, NY, 11561, US

(21) Appl. No.: 12/394,388

(22) Filed: Feb. 27, 2009

(51) Int. Cl. B32B 15/12

(52) U.S. Cl. 428/464

(57) ABSTRACT

A multi-layered food wrapping assembly includes at least one and preferably a plurality of sheets connected successively in series to form a roll. Each of the sheets has a flat bottom layer of flexible metal foil, a flat top layer of flexible absorbent material, and preferably an adhesive disposed between the bottom and top layers for releasably adhering together the bottom and top layers. The roll can be received within a dispensing box having a serrated edge, from which the sheets can be unrolled and detached via the serrated edge.

### BACKGROUND OF THE INVENTION

1. Field of the Invention

The invention is generally in the field of packaging materials for food preparation and storage. More particularly, the invention relates to a multi-layered food wrapping sheet which includes a layer of flexible metal foil which is adhered to a layer of flexible absorbent material for wrapping food therein.

2. Brief Description of the Prior Art

After consuming a meal, whether at home or at a restaurant, there is often leftover food. Rather than throwing away the leftover food, it can be packaged and stored for later consumption. Additionally, food is frequently packaged after it is prepared for takeout or delivery from a restaurant or to simply store it to eat in the future. Food packaging materials are also used while preparing foods.

Various articles are provided in the prior art to package and store food, such as, plastic containers, cardboard boxes, foil containers or various sheets of materials such as, plastic wrap, parchment paper, wax paper or foil. These articles have various disadvantages.

Typically, food storage containers are a predetermined size. This can result in wasted space when packaging smaller items of food or the container may be too small or of the wrong shape, to package larger or awkwardly shaped food items. Furthermore, such containers are often two-pieces, namely, a container portion and a lid portion. One piece of the container can be easily misplaced. This can lead to significant frustration when trying to find the matching lid for a container, or vice versa, resulting in wasted time searching for the matching piece and packaging the food. The containers may also take up significant storage space.

The various food wraps in the prior art which are used to package food also have various disadvantages. Particularly, plastic wrap is frequently used to wrap foods but it can be difficult to wrap foods having a wet surface, because the plastic wrap does not adhere well to the food. Additionally, the plastic wrap can often stick to itself and is difficult to use and unroll from the package.

Moreover, sheets of foil are frequently used to wrap foods. However, foil is difficult to use on foods being stored in the freezer because it can stick to the food it is contacting. This can cause frustration when trying to remove torn bits of foil from the food prior to consumption. Additionally, certain people avoid using aluminum foil to package their food as a health precaution because they do not want the metal directly contacting their food. Furthermore, wax and parchment paper can be disadvantageous as they are difficult to keep in a wrapped position around the food.

Another disadvantage when wrapping hot food items, is that water condensation can often form in the food containers. Furthermore, juices, grease and oils from the food can be deposited in the container.

While the prior art discloses many types of food wrapping or packaging materials, so far as is known, none of the prior art devices resolve all of these problems in a simple, effective and yet highly advantageous manner as does the present invention discussed herein.

### SUMMARY OF THE INVENTION

It is therefore an object of the invention to provide a novel food wrapping material.

It is another object of the invention to provide a food wrapping material which has a relatively simple construction, and is easy to use and store.

It is yet another object of the invention to provide a food wrapping material which maintains the freshness and flavors of the foods wrapped therein.

It is another object of the invention to provide a food wrapping material which wicks away and absorbs water condensation or excess juices, grease and oils in the foods.

It is a further object of the invention to provide a food wrapping material which prevents the juices, greases and oils in the food from seeping through the food wrapping material.

It is also an object of the invention to provide a food wrapping material which can accommodate foods of various sizes and shapes.

It is another object of the invention to provide a food wrapping material which can also be used for clean-up.

Certain of the foregoing and related objects are readily attained according to the present invention by the provision of a multi-layered food wrapping sheet, comprising a flat bottom layer of flexible metal foil, a flat top layer of flexible absorbent material, and an adhesive disposed between said bottom and top layers for releasably adhesively adhering said bottom and top layers together.

Preferably, the layer of absorbent material and the layer of metal foil are each generally rectangular and each has four side edges. The four side edges of said layer of absorbent material have a length which is less than the length of said four side edges of said layer of metal foil, and said layer of absorbent material is arranged centrally on said layer of metal foil thereby establishing an exposed rectangular edge portion of said layer of metal foil which extends peripherally beyond said four side edges of said layer of absorbent material. Advantageously, said metal foil is aluminum foil and said absorbent material is a paper towel. In a preferred embodiment, the absorbent material is a 2-ply paper towel. Furthermore, it is preferable that the adhesive is suitable for human ingestion.

Desirably, each of said four side edges of said layer of absorbent material define a side edge portion thereof extending along and adjacent to said four side edges of said layer of absorbent material. The adhesive is provided solely on said side edge portion. In another embodiment, the four side edges of said layer of absorbent material define four corners of said layer of absorbent material and said adhesive is provided solely adjacent to said four corners of said layer of absorbent material.

In an alternative embodiment, an assembly for wrapping food, comprises a plurality of sheets connected successively in series to form a continuous web having a longitudinal down-web direction and a lateral cross-web direction, said continuous web forming a roll. Each of said sheets comprise, a flat bottom layer of flexible metal foil, a flat top layer of flexible absorbent material and an adhesive disposed between said bottom and top layers for releasably adhesively adhering said bottom and top layers. Also provided is a dispensing box having a serrated edge, in which the roll can be contained and from which the sheets can be unrolled and detached via said serrated edge.

Preferably, the assembly further comprises longitudinally spaced, laterally extending separation lines between each of said sheets, and desirably, a plurality of perforations along said separation lines to aid separation of each of said sheets along said separation lines. In a preferred embodiment, the plurality of perforations are provided only on said layer of metal foil.

Preferably, the layer of absorbent material and said layer of metal foil are each generally rectangular and each has four side edges. The four side edges of said layer of absorbent material have a length which is less than the length of said four side edges of said layer of metal foil. The layer of absorbent material is most desirably arranged centrally on said layer of metal foil, thereby establishing an exposed rectangular edge portion of said layer of metal foil which extends peripherally beyond said four side edges of said layer of absorbent sheet.

Advantageously, said metal foil is aluminum foil and said absorbent material is a paper towel. In a preferred embodiment, the absorbent material is a 2-ply paper towel. Furthermore, it is preferable that the adhesive is suitable for human ingestion.

In a preferred embodiment, each of said four side edges of said layer of absorbent material define a side edge portion thereof extending along and adjacent to said four side edges of said layer of absorbent material. The adhesive is provided solely on said side edge portion. In another embodiment, the four side edges of said layer of absorbent material define four corners of said layer of absorbent material and said adhesive is provided solely adjacent to said four corners of said layer of absorbent material.

In yet another embodiment, the multi-layered food wrapping sheet comprises a flat bottom layer of flexible metal foil and a flat top layer of flexible absorbent material. The top layer of absorbent material is adhered to the bottom layer of metal foil.

Additional objects and advantages of the invention will become apparent to those skilled in the art upon reference to the detailed description taken in conjunction with the provided figures.

### BRIEF DESCRIPTION OF THE DRAWINGS

Preferred embodiments of the present invention will now be more particularly described by way of example with reference to the accompanying drawings, wherein:

FIG. 1 is a perspective view of the food wrapping material embodying the present invention being disposed in the form of a roll and contained within a dispensing box having a serrated edge, further showing the food wrapping material being unrolled from the box;

FIG. 2 is a plan view of several sheets of the food wrapping material unrolled from the roll shown in FIG. 1;

FIG. 3a is a cross-sectional view along line 3a-3a in FIG. 2;

FIG. 3b is a plan view of a single sheet of the food wrapping material further showing the glue line in phantom lines, along the periphery of the layer of absorbent material; and

FIG. 3c is a plan view of another embodiment of a single sheet of the food wrapping material further showing the glue spots in phantom lines, adjacent the corners of the layer of absorbent material.

### DETAILED DESCRIPTION OF THE PREFERRED EMBODIMENTS

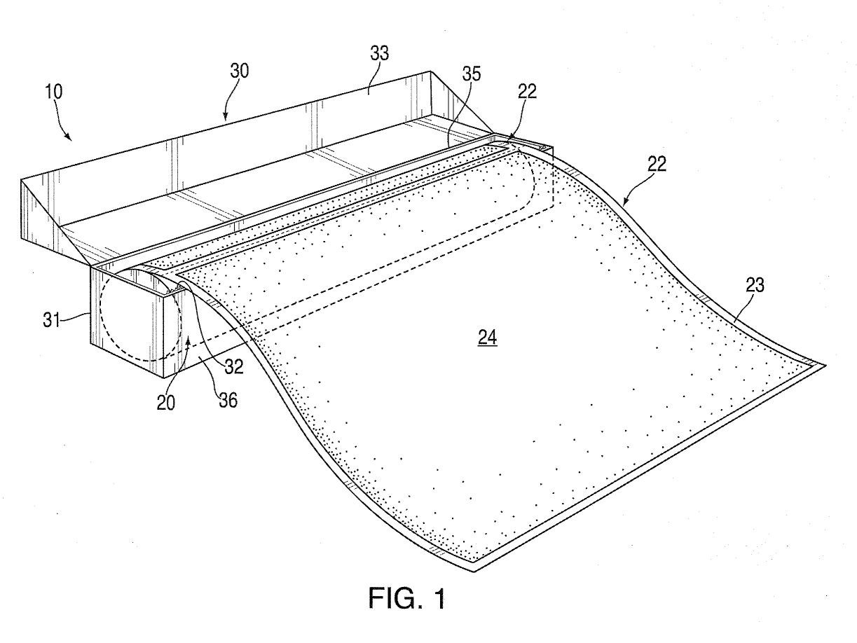

Turning now in detail to the drawings and, in particular, FIG. 1 thereof, therein illustrated is a novel food wrapping assembly according to the invention, generally designated by reference numeral 10, which is intended to be used for food preparation and storage. Assembly 10 comprises a multi-layered or multi-ply food wrapping material generally designated by reference numeral 20, which is intended to be used to wrap foods therein or place foods thereon. The food wrapping material 20 is received within a dispensing box generally designated by reference numeral 30.

As shown in FIG. 1, the food wrapping material 20 comprises a continuous web of a plurality of food wrapping sheets generally designated by reference numeral 22. The food wrapping sheets 22 are connected successively in series to form a continuous web of food wrapping material 20, which has a longitudinal down-web direction and a lateral cross-web direction. The food wrapping material 20 is formed or wound into the shape of a cylindrical roll and is received within dispensing box 30. The food wrapping sheets 22 can be unrolled from the cylindrical roll of the food wrapping material 20 and can be extracted from the dispensing box 30, as needed, for use in food preparation and storage.

The dispensing box 30 is comprised of a body 31 and a lid 33. The lid 33 is hingedly attached to the body 31 of the dispensing box 30 along edge 35. When the lid 33 is opened, the food wrapping sheets 22 of the food wrapping material 20 may be unrolled for use and extracted from the dispensing box 30, as needed. The dispensing box 30 has a serrated edge 32 along a top edge of side 36 on the body 31 of the dispensing box. The serrated edge 32 aids in the separation of the food wrapping sheets 22 from the food wrapping material 20, so that the sheets 22 may be used separately to wrap items of food.

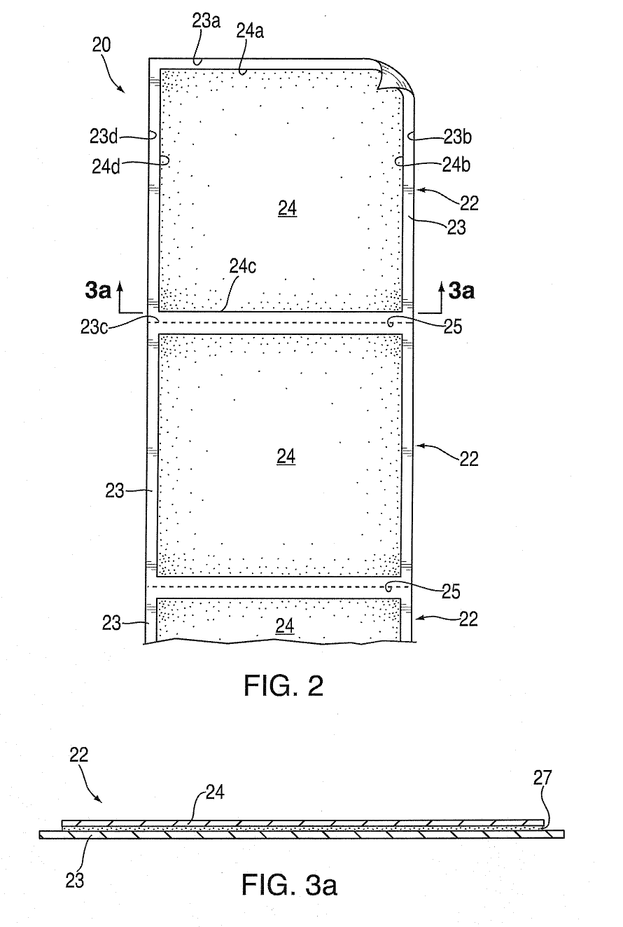

Turning now to FIG. 2, each of the food wrapping sheets 22 comprises a flat or planar bottom layer of flexible or pliable metal foil 23 and a flat or planar top layer of flexible or pliable absorbent material 24. The layer of metal foil 23 and the layer of absorbent material 24 are each generally rectangular. The layer of metal foil 23 has four side edges 23a, 23b, 23c, and 23d and the layer of absorbent material 24 has four side edges 24a, 24b, 24c, and 24d. The four side edges of the layer of absorbent material 24a, 24b, 24c, and 24d all have a length which is less than the length of the four side edges 23a, 23b, 23c, and 23d of the layer of metal foil 23. The layer or ply of absorbent material 24 is arranged centrally on the layer or ply of metal foil 23 thereby establishing an exposed rectangular edge portion of said ply of metal foil 23 which extends peripherally beyond said four side edges 24a, 24b, 24c and 24d of said ply of absorbent material 24 and is defined between said four side edges of said absorbent ply and said four sides edges 23a, 23b, 23c, and 23d of said metal foil ply 23.

Most advantageously, the layer of absorbent material is eleven inches (11″) by eleven inches (11″) and the layer of metal foil is twelve inches (12″) by twelve inches (12″), thereby forming a one-half (½″) exposed rectangular edge potion of the layer of metal foil which extends peripherally beyond the four side edges of the layer of absorbent material. Although, it will be appreciated that the food wrapping sheets 22 can be made smaller or larger or of a different shape, such as rectangular.

Items of food (not shown) may be placed on the layer of absorbent material 24 and the food wrapping sheet 22 can be wrapped around the items of food. A single sheet 22 may be used to wrap the food therein or multiple sheets 22 may be used as desired, such as to accommodate larger items of food.

The metal foil 23 is preferably made from aluminum foil. Additionally, the absorbent material 24 is preferably a paper towel which can be one or preferably two plies. The two-ply paper towel is advantageous as it increases absorbency. Desirably, the layer of absorbent material is in contact with the item of food. It can be appreciated that the layer of absorbent material wicks away and absorbs water condensation which may occur when wrapping hot foods, or excess juices, oils or grease from foods. Additionally, the layer of absorbent material and not the layer of metal foil is in direct contact with the food. However, the food wrapping sheet 22 is maintained around the food due to the layer of metal foil 23 which generally retains its wrapped enveloping shape. Furthermore, the layer of metal foil 23 prevents juices, oils, or greases from the foods from seeping out of the food wrapping material 20. Thus, the food wrapping material 20 is particularly advantageous for wrapping greasy foods, such as fried chicken, as the layer of absorbent material 24 absorbs excess grease and the layer of metal foil 23 prevents the juices and grease from escaping the food wrapped in the food wrapping sheet 22.

Furthermore, the roll of food wrapping material 20 contains a plurality of laterally extending perforations 25 forming separation lines between each of the sheets 22 which aids in the separation of each of the sheets 22 from the roll. When disposed within the dispensing box 30, the serrated edge 32 can be aligned with the perforations 25 to aid the user in separating each of the sheets 22 from the food wrapping material 20. Preferably, the perforations 25 are provided only on the layer of metal foil 23. However, it can be appreciated that they can be provided on the layer of absorbent material 24 and the layer of metal foil 23, if these plies were of the same size.

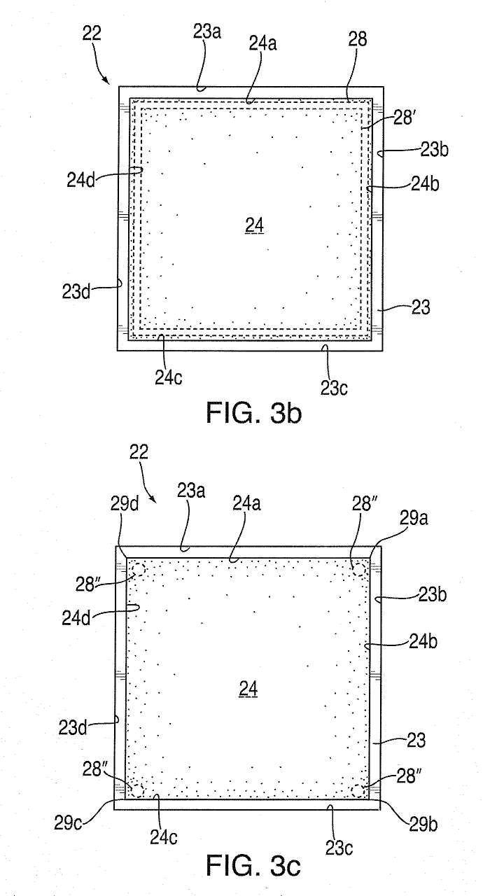

Turning to FIG. 3a, the layer of metal foil 23 is adhered via an adhesive 27 which is non-toxic and fit for human ingestion to the layer of absorbent material 24. Suitable adhesives are well known to those skilled in the art such as those listed in 21 C.F.R. §176.170 (2008) and the U.S. Food and Drug Administration, Center for Food Safety and Applied Nutrition/Office of Food Additive Safety. FDA's Inventory of Effective Food Contact Substances (FCS) Notifications [online]. February 2009. College Park, Maryland: 2009 [retrieved on 2009-02-18]. Retrieved from the Internet: <URL: http://www.cfsan.fda.gov/˜dms/opa-fcn.html>. The adhesive 27 is disposed between the bottom layer of metal foil 23 and the top layer of absorbent material 24. The adhesive releasably adhesively adheres the layer of metal foil 23 to the layer of absorbent material 24, so that the layers may be separated. As a result, the layer of absorbent material can be separated from the layer of metal foil and used separately, for example, as a napkin or for clean-up.

As shown in FIG. 3b, to aid manual release of the absorbent ply from the metal ply, the adhesive (not shown) is only applied within a rectangular border region space which is disposed inwardly of, and which extends generally along and adjacent to, the four side edges 24a, 24b, 24c, and 24d of the layer of absorbent material 24. The adhesive 27 is provided solely between phantom glue lines 28 and 28′, between the layer of absorbent material 24 and the layer of metal foil 23. As a result, only the side edges of the absorbent ply are adhered to the metal foil ply, thereby facilitating the manual detachment of the absorbent ply by hand (not shown) from the metal ply.

As seen in the further embodiment of FIG. 3c, to further ease the manual removal of the absorbent ply from the metal ply, the adhesive can simply be applied to the corners of the absorbent ply. Specifically, the four side edges 24a, 24b, 24c, and 24d of the layer of absorbent material 24 defines four corners 29a, 29b, 29c, and 29d of said layer of absorbent material 24 and the adhesive 27 (not viewable) is provided solely adjacent to the four corners 29a, 29b, 29c, and 29d of the layer of absorbent material 24. The glue spots 28″ are shown in phantom lines.

It will therefore be appreciated by those skilled in the art that other modifications could be made thereto without departing from the spirit and scope of the invention. For example, while the food wrapping material 20 is preferably formed into the shape of a cylindrical roll for compact storage and ease of use, it can also be arranged in other manners for example, as separately packaged single flat sheets or a plurality of folded sheets. For example, the sheets could be folded together but unattached to allow a user to quickly and easily grasp a single sheet at a time without the need for serration means.

Additionally, while the food wrapping material 20 is preferably stored in a dispensing box 30 as shown in FIG. 1, it can be stored in other manners, for example, in a dispensing box having a slot-like opening from which the sheets may be extracted or on a holder having a rod which can extend through the center of the cylindrical roll.

Furthermore, while the layer of metal foil which is aluminum foil is advantageous, other metal foils may be used. Similarly, while the layer of absorbent material is a paper towel, other absorbent material can also be used, such as parchment paper. Additionally, the layer of absorbent material can be of the same size as the layer of metal foil and provided as a continuous sheet, rather than having a border of aluminum foil around the layer of absorbent material.

In addition, other means may be provided to attach the layer of metal foil to the layer of absorbent material, for example, tabs or other mechanical interlocks can be formed in the metal foil itself and used to physically attach the metal foil ply to the paper ply via said tabs or the like. The adhesive can also be provided in different locations to adhere the layer of metal foil to the layer of absorbent material.

Furthermore, the layer of absorbent material may be plain white, or it can be imprinted with various words and designs such as, company logos, or seasonal and holiday designs.

Thus, while particular embodiments of the invention have been shown and/or described, it is not intended that the invention be limited thereto, as it is intended that the invention be as broad in scope as the prior art will allow and that the specification be read likewise.

What is claimed is:

1. A multi-layered food wrapping sheet, comprising:
a flat bottom layer of flexible metal foil;
a flat top layer of flexible absorbent material; and
an adhesive disposed between said bottom and top layers for releasably adhesively adhering said bottom and top layers together.

2. The food wrapping sheet according to claim 1, wherein:
said layer of absorbent material and said layer of metal foil are each generally rectangular and each has four side edges, wherein said four side edges of said layer of absorbent material have a length which is less than the length of said four side edges of said layer of metal foil, and said layer of absorbent material is arranged centrally on said layer of metal foil thereby establishing an exposed rectangular edge portion of said layer of metal foil which extends peripherally beyond said four side edges of said layer of absorbent material.

3. The food wrapping sheet according to claim 1, wherein:
said metal foil is aluminum foil.

4. The food wrapping sheet according to claim 1, wherein:
said absorbent material is a paper towel.

5. The food wrapping sheet according to claim 1, wherein:
said absorbent material is a 2-ply paper towel.

6. The food wrapping sheet according to claim 1, wherein:
said adhesive is suitable for human ingestion.

7. The food wrapping sheet according to claim 2, wherein:
each of said four side edges of said layer of absorbent material define a side edge portion thereof extending along and adjacent to said four side edges of said layer of absorbent material and wherein said adhesive is provided solely on said side edge portion.

8. The food wrapping sheet according to claim 2, wherein:
said four side edges of said layer of absorbent material define four corners of said layer of absorbent material and said adhesive is provided solely adjacent to said four corners of said layer of absorbent material.

9. An assembly for wrapping food, comprising:
a plurality of sheets connected successively in series to form a continuous web having a longitudinal down-web direction and a lateral cross-web direction, said continuous web forming a roll, each of said sheets comprising:
a flat bottom layer of flexible metal foil;
a flat top layer of flexible absorbent material; and
an adhesive disposed between said bottom and top layers for releasably adhesively adhering said bottom and top layers; and
a dispensing box having a serrated edge, in which the roll can be contained and from which the sheets can be unrolled and detached via said serrated edge.

10. The assembly according to claim 9, further comprising:
longitudinally spaced, laterally extending separation lines between each of said sheets.

11. The assembly according to claim 10, further comprising:
a plurality of perforations along said separation lines to aid separation of each of said sheets along said separation lines.

12. The assembly according to claim 11, wherein:
said plurality of perforations are provided only on said layer of metal foil.

13. The assembly according to claim 9, wherein:
said layer of absorbent material and said layer of metal foil are each generally rectangular and each has four side edges, wherein said four side edges of said layer of absorbent material have a length which is less than the length of said four side edges of said layer of metal foil, and said layer of absorbent material is arranged centrally on said layer of metal foil thereby establishing an exposed rectangular edge portion of said layer of metal foil which extends peripherally beyond said four side edges of said layer of absorbent sheet.

14. The assembly according to claim 9, wherein:
said metal foil is aluminum foil.

15. The assembly according to claim 9, wherein:
said absorbent material is a paper towel.

16. The assembly according to claim 9, wherein:
said absorbent material is a 2-ply paper towel.

17. The assembly according to claim 9, wherein:
said adhesive is suitable for human ingestion.

18. The assembly according to claim 13, wherein:
each of said four side edges of said layer of absorbent material define a side edge portion thereof extending along and adjacent to said four side edges of said layer of absorbent material and wherein said adhesive is provided solely on said side edge portion.

19. The assembly according to claim 13, wherein:
said four side edges of said layer of absorbent material define four corners of said layer of absorbent material and said adhesive is provided solely adjacent to said four corners of said layer of absorbent sheet.

20. A multi-layered food wrapping sheet, comprising:
a flat bottom layer of flexible metal foil; and
a flat top layer of flexible absorbent material adhered to said layer of flexible metal foil.
